(19) United States
(12) Patent Application Publication
(10) Pub. No.: US 2006/0183872 A1
(43) Pub. Date: Aug. 17, 2006

(54) Resin composition for embedded capacitors having excellent adhesive strength, heat resistance and flame retardancy

(75) Inventors: Seung Eun Lee, Sungnam (KR); Yul Kyo Chung, Yongin (KR); Hyo Soon Shin, Yongin (KR); Seung Hyun Sohn, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/352,238

(22) Filed: Feb. 13, 2006

(30) Foreign Application Priority Data
Feb. 15, 2005 (KR) 10-2005-0012483

(51) Int. Cl. C08L 63/00; C08L 75/04; B32B 27/38

(52) U.S. Cl. 525/527; 523/457; 428/413

(57) ABSTRACT

Disclosed herein is a resin composition for embedded capacitors having excellent adhesive strength, heat resistance and flame retardancy, a ceramic/polymer composite for embedded capacitors including the resin composition, a dielectric layer of a capacitor manufactured therefrom, and a printed circuit board. The resin composition for dielectric layers of embedded capacitors includes a resin selected from the group consisting of bisphenol-A epoxy resins, bisphenol-F epoxy resins and combinations thereof, a brominated epoxy resin containing 40 wt % or more bromine, and a resin selected from the group consisting of bisphenol-A novolac epoxy resins, multi-functional epoxy resins, polyimides, cyanate esters and combinations thereof, and exhibits excellent peel strength, Tg and/or flame retardancy. Further, a ceramic/polymer composite formed by adding a ceramic filler to the resin composition is provided. Furthermore, a dielectric layer formed of the ceramic/polymer composite and a printed circuit board including the dielectric layer are provided. According to the current invention, the ceramic/polymer composite for embedded capacitors, which realizes all of peel strength, Tg and flame retardancy, can be obtained.

### BACKGROUND OF THE INVENTION

1. Field of the Invention

The present invention relates to a resin composition for embedded capacitors, which realizes all of desired peel strength, Tg and flame retardancy while also realizing dielectric and magnetic properties by using a large amount of a filler, a ceramic/polymer composite for embedded capacitors formed by adding a ceramic filler to the resin composition, a dielectric layer of a capacitor including the ceramic/polymer composite, and a printed circuit board (PCB) including the dielectric layer of a capacitor.

2. Description of the Related Art

Recently, while a multilayered circuit board has been developed to be miniaturized and have a high frequency, passive devices, which have been generally mounted on a PCB, impede the miniaturization of products. In particular, semiconductor devices have increasingly trended towards being embedded and the number of input/output terminals has increased, and thus, it is difficult to assure the space required to dispose many passive devices including capacitors around active integrated circuit chips. Further, with the aim of supplying stable power to an input terminal, a decoupling capacitor is used. As such, the decoupling capacitor should be disposed nearest to the input terminal, to reduce the high frequency induced inductance.

To optimally dispose the capacitor around the active integrated circuit chips to correspond to the miniaturization and high frequency requirements of electronic devices, methods of mounting passive devices, such as the capacitor, directly below the integrated circuit chip have been proposed. Accordingly, a multilayered ceramic capacitor (MLCC) having low equivalent series inductance (low ESL) has been developed.

Moreover, to overcome the problems of high frequency induced inductance and realize miniaturization, embedded capacitors have been devised. The embedded capacitor is manufactured by forming one layer in a PCB below the active integrated circuit chip as a dielectric layer. The embedded capacitor is disposed nearest to the input terminal of the active integrated circuit chip, and thus, the length of the wire connected to the capacitor is minimized, thereby effectively reducing the high frequency induced inductance.

It is known that a dielectric material for capacitors used to realize the embedded capacitor includes, for example, a glass fiber reinforced epoxy resin called the FR4, which is used as a conventional PCB member. For necessary capacitance, a filler formed of ferroelectric ceramic powder having a high dielectric constant is dispersed in a polymer to obtain a composite, which is then used as a dielectric material for embedded composites. For example, as a highly dielectric composite for embedded capacitors, a composite formed by dispersing a BaTiO₃ filler which is a ferroelectric ceramic material in an epoxy resin is used. In this way, in the case where the polymer-ferroelectric ceramic composite is used as a dielectric material for embedded capacitors, the volume ratio of the ferroelectric ceramic filler to the polymer should increase so as to increase the dielectric constant.

When the dielectric constant is increased by increasing the volume ratio of the ferroelectric ceramic filler, dielectric and magnetic properties are improved. However, the resin, acting to exhibit adhesive strength, is used in a relatively low amount, thereby decreasing the peel strength of the resin to a metal foil, such as copper. Thus, due to low peel strength, problems in manufacturing reliable products are caused. In addition, the resin should have high heat resistance, that is, Tg of 180° C. or more, to maintain a predetermined shape during processes of applying heat at a high temperature, such as lamination or soldering, upon manufacturing the PCB. However, the higher the heat resistance of the resin, the lower the peel strength.

U.S. Pat. No. 6,462,147 discloses an epoxy resin composition for PCBs having high hygroscopicity, heat resistance and adhesive strength to a Cu foil, which contains a multi-functional phenol group, a curing accelerator, at least one of a compound having a triazine or isocyanurate ring, and a compound containing less than 60 wt % nitrogen, but not containing a urea derivative. However, the above patent is disadvantageous because the resin composition having excellent heat resistance, adhesive strength and flame retardancy is obtained not by using a different kind of epoxy resin but by using an additive.

### SUMMARY OF THE INVENTION

Accordingly, the present invention has been made keeping in mind the above problems occurring in the related art, and an object of the present invention is to provide a resin composition for embedded capacitors, which realizes all of peel strength, Tg and flame retardancy as a PCB material.

Another object of the present invention is to provide a ceramic/polymer composite for embedded capacitors, which realizes peel strength, Tg and flame retardancy.

A further object of the present invention is to provide an embedded dielectric layer realizing peel strength, Tg and flame retardancy, and a PCB including the embedded dielectric layer.

In order to accomplish the above objects, according to a first aspect of the present invention, a resin composition for embedded capacitors is provided, which comprises 10-40 wt % of a brominated epoxy resin containing 40 wt % or more bromine, and 60-90 wt % of at least one resin selected from the group consisting of bisphenol-A novolac epoxy resins, multi-functional epoxy resins, polyimides, cyanate esters and combinations thereof.

According to a second aspect of the present invention, a resin composition for embedded capacitors is provided, which comprises 1-50 wt % of at least one resin selected from the group consisting of bisphenol-A epoxy resins, bisphenol-F epoxy resins and combinations thereof, 9-60 wt % of a brominated epoxy resin containing 40 wt % or more bromine, and 30-90 wt % of at least one resin selected from the group consisting of bisphenol-A novolac epoxy resins, multi-functional epoxy resins, polyimides, cyanate esters and combinations thereof.

According to a third aspect of the present invention, a ceramic/polymer composite for embedded capacitors is provided, which comprises 50-70 vol % of the resin composition and 30-50 vol % of a ferroelectric ceramic filler.

According to a fourth aspect of the present invention, a dielectric layer of a capacitor is provided, which is formed of the ceramic/polymer composite for dielectric layers of embedded capacitors.

According to a fifth aspect of the present invention, a PCB is provided, which comprises the dielectric layer of a capacitor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a contour plot showing Tg varying with the amount of each epoxy resin;

FIG. 2 is a contour plot showing peel strength varying with the amount of each epoxy resin; and

FIG. 3 is a contour plot showing Tg and peel strength varying with the amount of each epoxy resin.

### DESCRIPTION OF THE PREFERRED EMBODIMENTS

Hereinafter, a detailed description will be given of the present invention.

Table 1, below, shows peel strength, Tg and whether flame retardancy meets a UL94-V0 rating, for epoxy resins represented by Formulas 1 to 3 serving as material for dielectric layers for embedded capacitors. As such, the dielectric layer material further includes a ceramic filler in addition to the resin, and thus, has lower peel strength than the resin alone, depending on the amount of ceramic filler. In general, in the case where the ceramic filler is used in an amount of 80 wt %, the peel strength appears to decrease by 30%. On the other hand, since the ceramic filler has flame retardancy, when the ceramic filler is further included, the flame retardancy of the dielectric layer material is increased compared to that of the resin alone. That is, although the resin alone does not meet the V0 rating, the composite of ceramic filler and resin meets the V0 rating, attributable to the addition of the ceramic filler.

A bisphenol-A epoxy resin represented by Formula 1, below, which is generally used because it has a low viscosity and exhibits flexibility when cured, has high peel strength of 1.8 kN/m. However, this resin has very low Tg of 120° C. and flame retardancy not meeting the V0 rating, and thus, it is unsuitable for use in PCB material. This epoxy resin does not meet the V0 rating even if the ceramic filler is added thereto.

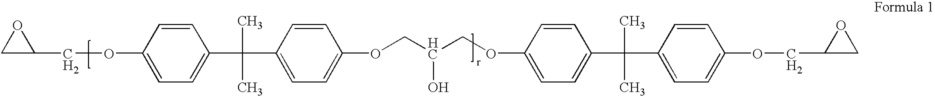

In addition, a brominated epoxy resin represented by Formula 2, below, which has higher peel strength and improved flame retardancy than the above epoxy resin due to the addition of bromine, has excellent peel strength and flame retardancy, but has Tg of 140° C. that does not reach a high Tg resin system (180° C. or more).

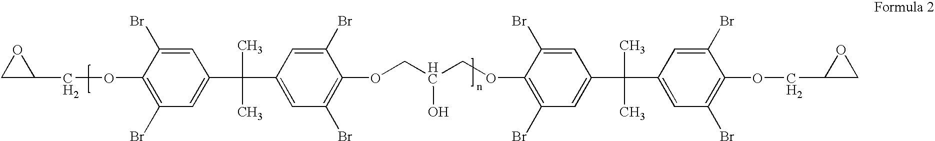

In addition, a novolac-type epoxy resin represented by Formula 3, below, has Tg of 220° C. that is higher than the typically required 180° C., but this resin has peel strength of 1.0 kN/m with a variation of 0.1. When this resin is used for an embedded capacitor, a relative amount of the resin is decreased due to the addition of ceramic filler thereto, thereby reducing the peel strength by 30%. Hence, the resin cannot be used as a PCB material. Also, the above resin does not meet the V0 rating for flame retardancy, even if the ceramic filler is used in an amount of 80 wt %.

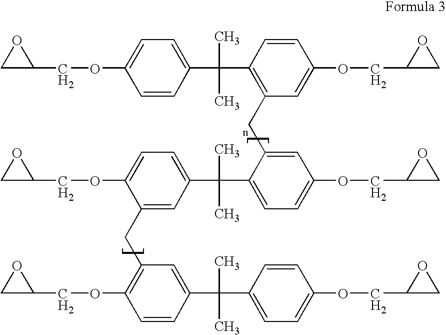

TABLE 1

| | Peel | | | Flame Retardancy |
|---|---|---|---|---|
| | Strength | | Tg | (Whether meeting V0 |
| Epoxy Resin | (kN/m) | Variation | (° C.) | Rating) |
| Bisphenol-A Epoxy | 1.8 | 0.02 | 120 | X |
| Resin | | | | |
| Brominated Epoxy | 2.2 | 0.04 | 140 | ◯ |
| Resin | | | | |
| Novolac-type Epoxy | 1.0 | 0.1 | 220 | X |
| resin | | | | |

In this way, it is very difficult to realize all of the three properties, such as peel strength, Tg and flame retardancy, essentially required for the material for embedded capacitors.

Therefore, the present invention provides a material for embedded capacitors, which realizes all of peel strength, Tg and flame retardancy.

According to a first embodiment of the present invention, a resin mixture used along with a filler as a PCB material is provided, which includes at least two resins to increase Tg.

The resin mixture is composed of at least two resins among at least one resin (resin A) selected from the group consisting of bisphenol-A epoxy resins, bisphenol-F epoxy resins and combinations thereof, a brominated epoxy resin containing 40 wt % or more bromine (resin B), and at least one resin (resin C) selected from the group consisting of bisphenol-A novolac epoxy resins, multi-functional epoxy resins, polyimides, cyanate esters and combinations thereof.

The resin mixture includes 0-30 wt % of the resin A, 10-40 wt % of the resin B, and 60-90 wt % of the resin C.

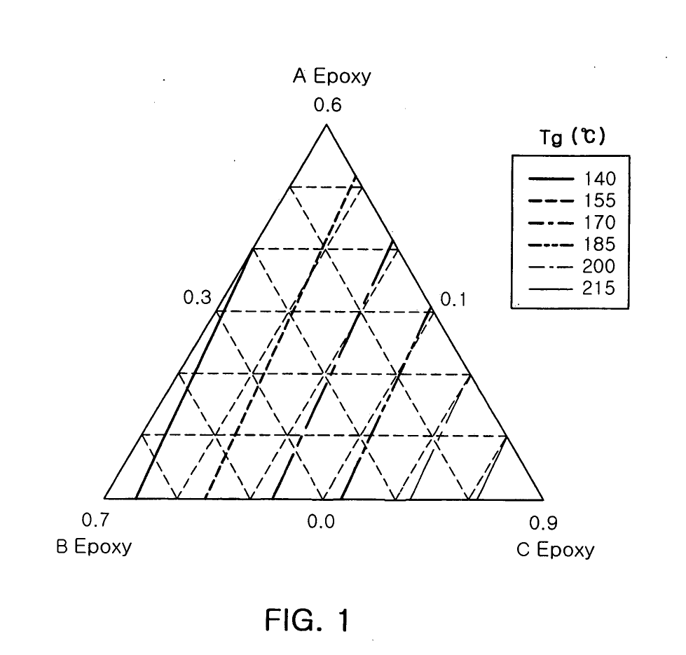

Among three kinds of resin, the bisphenol-A epoxy resin (epoxy resin A), the brominated epoxy resin having 40 wt % or more bromine (epoxy resin B), and the bisphenol novolac epoxy resin (epoxy resin C) are mixed at a predetermined ratio and then cured, followed by measuring Tg. The results are contour plotted in FIG. 1.

The resin for use in a PCB requires high heat resistance, that is, Tg of 180° C. or more, to maintain a predetermined shape during processes of applying heat at a high temperature, such as lamination or soldering, upon manufacturing the PCB.

Hence, Tg of 180° C. or more is obtained when the resin mixture is used in the composition disclosed above, as is apparent from FIG. 1. The larger the amount of epoxy resin C having high Tg, the higher the Tg.

According to a second embodiment of the present invention, a resin composition comprising all of a resin A, a resin B, and a resin C is provided. Specifically, the resin composition is composed of 1-50 wt % of the resin A, 9-60 wt % of the resin B, and 30-90 wt % of the resin C. As such, each resin used for the resin mixture may include the same resins as the resins used to increase Tg according to the first embodiment of the present invention.

In particular, as a resin used along with a filler as a PCB material, the resin composition of the present invention to increase the peel strength is preferably composed of 5-50 wt % of the resin A, 10-60 wt % of the resin B, and 30-85 wt % of the resin C. More preferably, 15-45 wt % of the resin A, 15-50 wt % of the resin B, and 30-70 wt % of the resin C are contained.

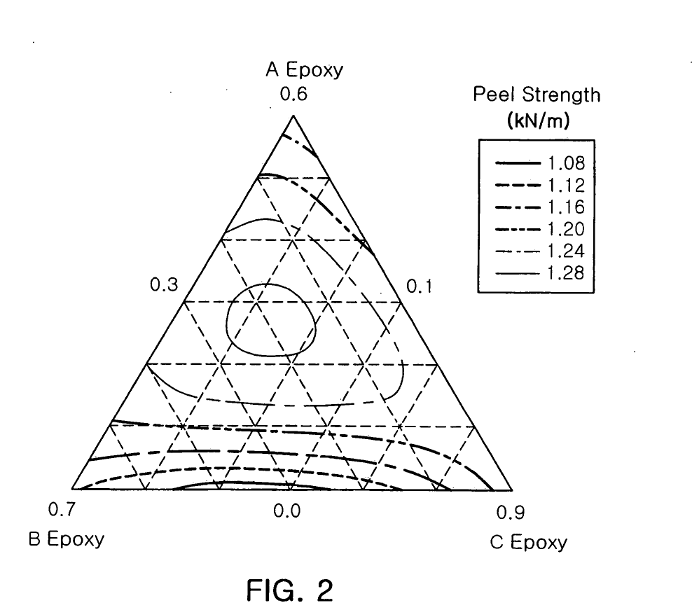

Among three kinds of resin, a bisphenol-A epoxy resin (epoxy resin A), a brominated epoxy resin having 40 wt % or more bromine (epoxy resin B), and a bisphenol novolac epoxy resin (epoxy resin C) are mixed at a predetermined ratio and then cured, followed by measuring Tg. The results are contour plotted in FIG. 2.

The dielectric layer material for embedded capacitors consists of the resin and the ceramic filler, and therefore, has lower peel strength than the resin alone, depending on the amount of ceramic filler. In general, if the ceramic filler is added in an amount of 80 wt % (45 vol %), the peel strength decreases by 30%. In order to use the resin for a reliable PCB without peeling due to decrease in adhesive strength relative to a metal foil, peel strength of the resin including the ceramic filler should be 0.8 kN/m or more. Thus, the resin alone should have peel strength of about 1.2 kN/m or more, in consideration of the fact that the peel strength is reduced by about 30% upon the addition of filler.

With the aim of realizing peel strength of 1.2 kN/m or more, the resin mixture should be used in the composition disclosed above, as shown in FIG. 2. From the results, it can be seen that the epoxy resins A, B and C function together to manifest the desired final peel strength. In particular, the epoxy resin A functions to impart flexibility so as to decrease large variation in peel strength caused by the epoxy resin C. If the epoxy resin A is not included, the value of peel strength has been confirmed to significantly decrease.

As a resin used along with a filler as a PCB material, the resin composition of the present invention for simultaneous improvement of Tg and peel strength preferably includes 5-30 wt % of the resin A, 10-30 wt % of the resin B, and 60-85 wt % of the resin C. More preferably, 15-25 wt % of the resin A, 15-25 wt % of the resin B, and 60-70 wt % of the resin C are contained.

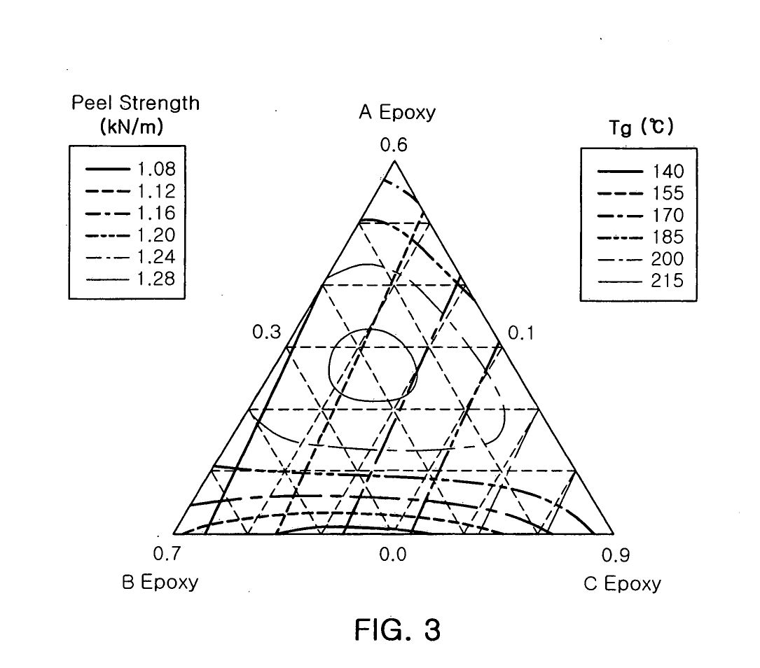

Among three kinds of resin, a bisphenol-A epoxy resin (epoxy resin A), a brominated epoxy resin having 40 wt % or more bromine (epoxy resin B), and a bisphenol novolac epoxy resin (epoxy resin C) are mixed at a predetermined ratio and then cured, followed by measuring Tg. The results are contour plotted in FIG. 3.

To be usable for a PCB, a dielectric layer of a capacitor formed of a ceramic/polymer composite should have Tg of 180° C. or more and peel strength of 0.8 kN/m (1.2 kN/m without the addition of filler). Further, the dielectric layer should meet the UL94-V0 rating for flame retardancy. Since the ceramic filler has flame retardancy, when the ceramic filler is further included, the flame retardancy of the dielectric layer material is increased compared to that of the resin alone. That is, although the resin does not meet the V0 rating, the composite of ceramic filler and resin meets the V0 rating.

In the present invention, if too little resin A is used, the cured resin may undesirably break loose. On the other hand, if too much resin A is used, Tg is undesirably decreased. The resin A is preferably used in an amount of 5-30 wt %, but is not limited thereto. As the resin B, the brominated epoxy resin contains bromine to increase flame retardancy. In the case where the resin B is used along with a predetermined amount or more of ceramic filler, it meets the rating for flame retardancy. Hence, if the resin B, greatly affecting flame retardancy, is used in an amount less than 9 wt %, flame retardancy is insignificantly increased. Meanwhile, if the resin B is used in an amount exceeding 60 wt %, Tg and peel strength are deteriorated. Use of the resin C in an amount less than 30 wt % results in an undesirably low Tg, whereas use of the resin C exceeding 90 wt % leads to large variation in peel strength.

According to a third embodiment of the present invention, a ceramic/polymer composite for embedded capacitors is provided, which includes the resin composition and the ferroelectric ceramic filler having a high dielectric constant mixed together.

As the ceramic filler of the present invention, a filler commonly used in the art may be utilized. For example, the ceramic filler used in the present invention includes BaTiO₃ or BaCaTiO₃. As such, the ceramic filler is present in the form of being dispersed in the resin composition.

In the ceramic/polymer composite, the resin mixture and the ceramic filler are used in amounts of 50-70 vol % and 30-50 vol %, respectively, based on the total volume of the ceramic/polymer composite. When the ceramic filler is used within the above range, the ceramic/polymer composite meets the UL94-V0 rating for flame retardancy even though the resin alone does not meet the rating for flame retardancy. If the ceramic filler is used in an amount less than 30 vol %, capacitance decreases. Meanwhile, if the ceramic filler is used in an amount exceeding 50 vol %, adhesive strength is undesirably weakened by the use of less epoxy resin.

The ceramic/polymer composite for dielectric layers of embedded capacitors, which includes the resin mixture and the ceramic filler, has Tg of 180° C. or more and peel strength of 0.8 kN/m or more while simultaneously meeting the UL94-V0 rating for flame retardancy. Thus, the above composite has excellent adhesive strength, heat resistance and flame retardancy.

The ceramic/polymer composite may further include an additive, such as a curing agent, a curing accelerator, a defoaming agent and/or a dispersing agent. The kinds and amounts of such components may be appropriately chosen by those skilled in the art, if necessary.

In the case of using the epoxy resin, a generally known curing agent for epoxy resin may be used. Curing agents for epoxy resin include, for example, but are not limited to, phenols such as phenol novolacs, amines such as dicyanguanidines, dicyandiamides, diaminodiphenylmethanes or diaminodiphenyl sulfones, acid anhydrides such as pyromellitic anhydrides, trimellitic anhydrides or benzophenone tetracarboxylic anhydrides, or combinations thereof.

According to a fourth embodiment of the present invention, a dielectric layer of a capacitor having excellent heat resistance, adhesive strength and flame retardancy is provided, which is formed of the ceramic/polymer composite including the resin mixture and the ceramic filler.

According to a fifth embodiment of the present invention, a PCB is provided, which includes the dielectric layer having excellent heat resistance, adhesive strength and flame retardancy.

A better understanding of the present invention may be obtained in light of the following Examples which are set forth to illustrate, but are not to be construed to limit the present invention.

In the following Examples, a method of mixing resins A, B and C represented by Formulas 1, 2 and 3 was used to obtain a resin mixture for dielectric layers of embedded capacitors realizing all of peel strength, Tg and flame retardancy.

### EXAMPLE 1

A bisphenol-A epoxy resin (epoxy resin A), a brominated epoxy resin containing 40 wt % or more bromine (epoxy resin B), and a bisphenol-A novolac epoxy resin (epoxy resin C) were mixed and dissolved in an amount of 80 wt % in 2-methoxyethanol. To the reaction solution, 0.8 eq bisphenol-A novolac resin serving as a curing agent and 0.1 wt % 2MI (2-methylimidazole) serving as a curing accelerator were further added, and the obtained solution was then mixed at 50° C. The resultant mixture was cast on a Cu foil and then semi-cured to a B-stage for 2.5 min in an oven at 170° C., to obtain a resin coated copper foil (RCC). Subsequently, two RCCs were laminated at 200° C. and cured. Thereafter, Tg, peel strength, and flame retardancy (whether meeting the V0 rating) were measured.

The results for Tg and peel strength varying with the amount of epoxy resin are shown in Table 2, below, and are also contour plotted in FIGS. 1 to 3.

TABLE 2

| | Epoxy | Epoxy | Epoxy | | Peel |
|---|---|---|---|---|---|
| | Resin A | Resin B | Resin C | Tg | Strength |
| No. | (wt %) | (wt %) | (wt %) | (° C.) | (kN/m) |
| 1 | 20 | 10 | 70 | 196.49 | 1.178 |
| 2 | 0 | 50 | 50 | 184.22 | 0.985 |
| 3 | 20 | 50 | 30 | 144.64 | 1.245 |
| 4 | 0 | 30 | 70 | 194.43 | 1.301 |
| 5 | 0 | 40 | 60 | 175.36 | 1.045 |
| 6 | 20 | 30 | 50 | 167.56 | 1.327 |
| 7 | 10 | 50 | 40 | 141.83 | 1.196 |
| 8 | 10 | 20 | 70 | 195.67 | 1.315 |
| 9 | 10 | 35 | 55 | 174.49 | 1.175 |
| 10 | 15 | 52.2 | 62.5 | 194.54 | 1.23 |
| 11 | 5 | 54.2 | 52.5 | 168.8 | 0.994 |
| 12 | 15 | 42.5 | 42.5 | 145.09 | 1.236 |
| 13 | 5 | 32.5 | 62.5 | 189.17 | 1.193 |

### EXAMPLE 2

An 80 wt % mixture comprising 20 wt % of a bisphenol-A epoxy resin (epoxy resin A), 20 wt % of a brominated epoxy resin containing 40 wt % or more bromine (epoxy resin B), and 60 wt % of a bisphenol-A novolac epoxy resin (epoxy resin C) was dissolved in 2-methoxyethanol. To the reaction solution, 0.8 eq bisphenol-A novolac resin, serving as a curing agent, and 0.1 wt % 2MI, serving as a curing accelerator, were further added and the obtained solution was then mixed at 50° C. The resultant mixture was further mixed with a dispersing agent, a defoaming agent, and BaCaTiO₃ amounting to 45 vol % as a filler, cast on a Cu foil and then semi-cured to a B-stage for 2.5 min in an oven at 170° C., to obtain an RCC. Subsequently, two RCCs were laminated at 200° C. and cured. Then, Tg, peel strength, and flame retardancy (whether meeting the V0 rating) were measured.

The measured properties compare those in Example 1 having the same composition as the above resin mixture, with the exception of the ceramic filler, and the results are shown in Table 3, below.

TABLE 3

| | Peel | | | Flame Retardancy |
|---|---|---|---|---|
| | Strength | | Tg | (Whether meeting |
| Kind of Epoxy Resin | (kN/m) | Variation | (° C.) | V0 Rating) |
| Composition of Ex. 1 | 1.24 | 0.04 | 182 | X |
| Composition of Ex. 1 + | 0.8 | 0.03 | 180 | ◯ |
| Ceramic Filler | | | | |

As is apparent from the above Table 2, although the resin alone does not meet the V0 rating, the composite containing 80 wt % (45 vol %) of a ceramic filler realizes all of peel strength, Tg and flame retardancy.

Therefore, the PCB including the dielectric layer formed of the resin composition of the present invention and ceramic filler may be manufactured using an excellent material realizing all of peel strength, Tg and flame retardancy, which are requirements for PCB materials.

In addition, the ceramic/polymer composite having properties suitable for desired purposes may be manufactured by use of the contour plot shown in FIG. 3.

As described hereinbefore, the present invention provides a resin composition for embedded capacitors. In the present invention, three kinds of epoxy resin are mixed, and thus, excellent properties of epoxy resins, for example, flexibility of the bisphenol-A epoxy resin, flame retardancy of the brominated epoxy resin, and heat resistance of the bisphenol-A novolac epoxy resin, are manifested together, thereby obtaining a ceramic/polymer composite that realizes all of peel strength, Tg and flame retardancy. Further, the ceramic/polymer composite is applied to embedded capacitors, therefore realizing excellent adhesive strength and flame retardancy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A resin composition for embedded capacitors, comprising:
10-40 wt % of a brominated epoxy resin having 40 wt % or more bromine; and
60-90 wt % of at least one resin selected from the group consisting of bisphenol-A novolac epoxy resins, multi-functional epoxy resins, polyimides and cyanate esters.

2. The resin composition as set forth in claim 1, further comprising 0-30 wt % of at least one resin selected from the group consisting of bisphenol-A epoxy resins and bisphenol-F epoxy resins and having Tg of 180° C. or more.

3. A resin composition for embedded capacitors, comprising:
1-50 wt % of at least one resin selected from the group consisting of bisphenol-A epoxy resins and bisphenol-F epoxy resins;
9-60 wt % of a brominated epoxy resin having 40 wt % or more bromine; and
30-90 wt % of at least one resin selected from the group consisting of bisphenol-A novolac epoxy resins, multi-functional epoxy resins, polyimides and cyanate esters.

4. The resin composition as set forth in claim 3, wherein the resin composition comprises:
1-30 wt % of the at least one resin selected from the group consisting of bisphenol-A epoxy resins and bisphenol-F epoxy resins;
10-39 wt % of the brominated epoxy resin; and
60-90 wt % of the at least one resin selected from the group consisting of bisphenol-A novolac epoxy resins, multi-functional epoxy resins, polyimides and cyanate esters.

5. The resin composition as set forth in claim 4, wherein the resin composition has Tg of 180° C. or more.

6. The resin composition as set forth in claim 3, wherein the resin composition comprises:
5-50 wt % of the at least one resin selected from the group consisting of bisphenol-A epoxy resins and bisphenol-F epoxy resins;
10-60 wt % of the brominated epoxy resin; and
30-85 wt % of the at least one resin selected from the group consisting of bisphenol-A novolac epoxy resins, multi-functional epoxy resins, polyimides and cyanate esters.

7. The resin composition as set forth in claim 6, wherein the resin composition has peel strength of 1.2 kN/m or more.

8. The resin composition as set forth in claim 3, wherein the resin composition comprises:
5-30 wt % of the at least one resin selected from the group consisting of bisphenol-A epoxy resins and bisphenol-F epoxy resins;
10-30 wt % of the brominated epoxy resin; and
60-85 wt % of the at least one resin selected from the group consisting of bisphenol-A novolac epoxy resins, multi-functional epoxy resins, polyimides and cyanate esters.

9. The resin composition as set forth in claim 8, wherein the resin composition has Tg of 180° C. or more and peel strength of 1.2 kN/m or more.

10. A ceramic/polymer composite for embedded capacitors, comprising:
50-70 vol % of the resin composition of claim 3; and
30-50 vol % of a ferroelectric ceramic filler.

11. A ceramic/polymer composite for embedded capacitors, comprising:
50-70 vol % of the resin composition of claim 6; and
30-50 vol % of a ferroelectric ceramic filler.

12. A ceramic/polymer composite for embedded capacitors, comprising:
50-70 vol % of the resin composition of claim 8; and
30-50 vol % of a ferroelectric ceramic filler.

13. The ceramic/polymer composite as set forth in claim 12, wherein the ferroelectric ceramic filler is BaTiO₃ or BaCaTiO₃.

14. The ceramic/polymer composite as set forth in claim 12, wherein the ceramic/polymer composite has Tg of 180° C. or more, peel strength of 0.8 kN/m or more, and flame retardancy meeting a rating of UL94-V0.

15. The ceramic/polymer composite as set forth in claim 12, further comprising at least one additive selected from the group consisting of a curing agent, a curing accelerator, a defoaming agent, and a dispersing agent.

16. A dielectric layer of a capacitor, formed of the ceramic/polymer composite for embedded capacitors of claim 14.

17. A printed circuit board, comprising the dielectric layer of claim 16.
